(19) United States
(12) Patent Application Publication
(10) Pub. No.: US 2012/0296664 A1
(43) Pub. Date: Nov. 22, 2012

(54) METHOD FOR ORGANIZING CLINICAL TRIAL DATA

(76) Inventors: Rajesh Nair, Princeton, NJ (US); Sanjay Parikh, Mumbai (IN)

(21) Appl. No.: 13/522,708

(22) PCT Filed: Jan. 21, 2011
(86) PCT No.: PCT/IB11/50268

§ 371 Date: Jul. 17, 2012

(30) Foreign Application Priority Data
Jan. 21, 2010 (IN) 142/CHE/2010

(51) Int. Cl. G06Q 50/22

(52) U.S. Cl. 705/2

(57) ABSTRACT

A method for creating multiple tagged clinical trial data and a tool therefrom is disclosed. The method comprises receiving clinical trial information from different sources, and removing redundancies from the clinical trial information received from the plurality of sources to form collated clinical trial data. The method further involves baseline tagging of the collated clinical data using non-indication parameters, creating a disease specific list of indication parameters, where indication parameters are classified into at least main indication parameters and sub indication parameters. The method further includes advanced tagging of the collated clinical trial data using indication parameters and creating multiple tagged clinical data using baseline tagging and advanced tagging.

### TECHNICAL FIELD

The invention relates generally to clinical trial management and more specifically to a method for organizing clinical trial data for efficient retrieval and use.

### BACKGROUND

In the medical field, clinical trials are typically conducted to allow safety and efficacy data to be collected for drugs, diagnostics, devices, therapy protocols, and other health or disease management related aspects. There are details procedures that need to be followed by corporates, research or health organizations to plan and conduct the trials for any new and/or development phase drugs, diagnostics, devices, therapy protocols, etc. The trial planning involves selection of the sites or centres where the trial would be conducted, these could be single center in one country or multiple centers in different countries. Similarly, there is a choice of healthy volunteers and/or patients depending on the type of product for which clinical trial is being conducted. Besides these, there are elaborate lab procedures that need to be selected for the clinical trials.

Clinical trials thus involve efficient planning and huge costs for all of the above mentioned activities, and design of clinical trials is critical to ensure that one gets relevant results for the product being tested. Clinical trials are also usually required before the national regulatory authority approves marketing of the drug or device, or a new dose of the drug, for use on patients.

The information from the ongoing and completed clinical trials is therefore very valuable to all those who may be engaged in similar research efforts for effective new clinical trial design. Currently, the information pertaining to clinical trials is available from discrete information sources. An indicative list of such information sources includes public domain sources like the website www.Clinicaltrials.gov, World Health Organization's clinical trial registry, and country specific clinical trial registry like Indian clinical trial registry, Sri Lankan clinical trial registry etc.; a company specific clinical trial registry like Glaxo SmithKline clinical trial registry, Roche clinical trial registry, etc.; and literature resources like PubMed, conference abstracts, and the like. The clinical trial data currently available is huge and widely dispersed.

There have been some inter-governmental efforts to provide a portal to access clinical trial information from select databases, for example the IFPMA Clinical Trial Portal that provides links to ClinicalStudyResults.org, ClinicalTrials.gov, Current Controlled Trials, Japan Pharmaceutical Information Center, and Pharmaceutical Industry Clinical Trials database. However, these efforts currently lack integration of all the different sources of information and the search features are limited.

Therefore there is a continuing need to address issues related to accessing clinical data information from all the different sources with ease and analyzing the data to find out the progress of any trial or results therefrom.

Accordingly there is a need to have a single window platform that is able to access all the different information sources and provide usable information on time and with speed.

### BRIEF DESCRIPTION

In one aspect, the invention provides a method for creating multiple tagged clinical trial data. The method comprises receiving clinical trial information from different sources, and removing redundancies from the clinical trial information received from the plurality of sources to form collated clinical trial data. The method further involves baseline tagging of the collated clinical data using non-indication parameters, creating a disease specific list of indication parameters, where indication parameters are classified into at least main indication parameters and sub indication parameters. The method further includes advanced tagging of the collated clinical trial data using indication parameters and creating multiple tagged clinical data using baseline tagging and advanced tagging.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of the overall method for creating an enhanced trial database that includes multiple tagged data; and

FIG. 2 is a diagrammatic representation of different components to enable the method of FIG. 1.

### DETAILED DESCRIPTION

As used herein and in the claims, the singular forms “a,” “an,” and “the” include the plural reference unless the context clearly indicates otherwise.

The clinical trial, or simply trials herein, refers to a health intervention study and includes but is not limited to studies related to drugs, devices, dosages, therapy protocols, diagnostics.

As used herein the clinical trial data is data or information available at any time point after initiation of a clinical trial including clinical study design. As one of ordinary skill in the art will appreciate, different data will become available at different stages of clinical trials, all of which are meant to be included as clinical trial data. Thus, for example, a clinical study design alone may be clinical trial data, or in the middle of a clinical trial, data such as investigators, geography, experimental details, and the like will constitute clinical trial data, while at the completion of a clinical trial, data such as results, end points, and so on will also be included as part of clinical trial data.

The clinical trial management as used herein refers to management of clinical trials. The management of clinical trial is achieved using the clinical trial data as defined herein.

The indication area as used herein refers to a condition which makes a particular treatment or procedure advisable.

The non-indication parameters as used herein refer to parameters, which are seen across the clinical trials irrespective of indication area the trial was conducted. Thus the non-indication parameters are independent of an indication area. The exemplary but non-limiting non-indication parameters include Trial Phase, Trial Status, Study design, Race, Gender, Age, Study sponsor, Investigator, Trial Site, Drug, Treatment duration, and Intervention type.

The indication parameters as used herein refer to parameters that are specific for a given indication area. The exemplary but non-limiting indication parameters include Patient segment, Inclusion criteria, Exclusion criteria, Endpoints—Efficacy & Safety, and Diagnostic and Laboratory parameters.

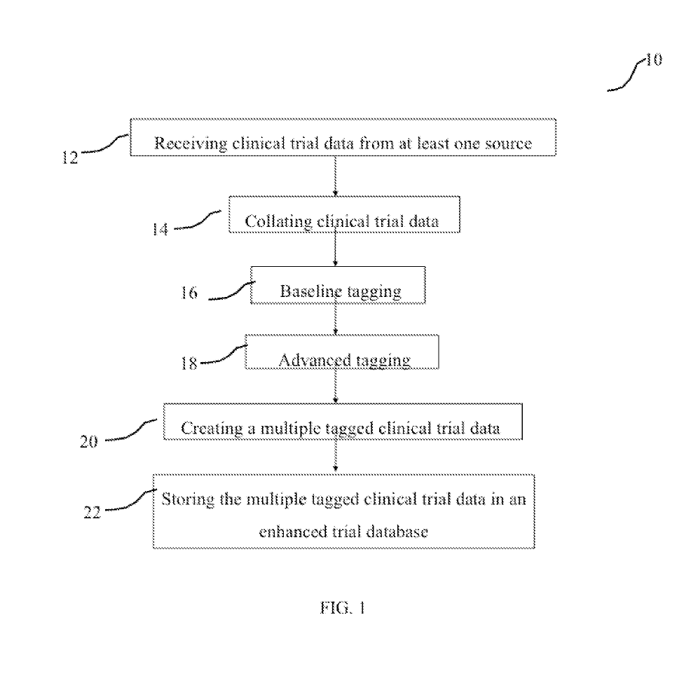

According to one aspect, a method for creating multiple tagged clinical trial data is provided and is shown generally as flowchart 10 in FIG. 1. The method includes receiving clinical trial data and information from multiple sources as indicated at step 12 of the flowchart. Such sources include the website www.Clinicaltrials.gov, World Health Organization's clinical trial registry, and country specific clinical trial registry like Indian clinical trial registry, Sri Lankan clinical trial registry etc.; company specific clinical trial registry like Glaxo SmithKline clinical trial registry, Roche clinical trial registry, etc.; literature resources like PubMed, conference abstracts, and the like. In the exemplary embodiment, the information is collected from such sources using crawlers that are usually written using a dynamic programming language, such as Perl programming language, and then stored in a database.

The method further involves removing redundancies from the clinical trial information received from these sources to form collated clinical trial data as shown at step 14 of the flowchart. The removal of redundancies is based on at least a statistical keyword match done for same clinical trial information from a source and/or from at least two sources from the multiple sources to yield the collated data that is free of redundancies. Also, the collated data as described herein includes a clustered clinical trial data after removing the redundancies. For example, a given clinical trial can be represented in multiple sources, with the same title or a different title conveying the same meaning. For example, when three different sources for trial data such as the websites clinicaltrials.gov, WHO website for clinical trials and Indian clinical trial registry are searched for a trail ID NCT00455533, they all show only one trial information for measuring the efficacy of four drugs Cyclophosphamide, Doxorubicin, Ixabepilone, Paclitaxel in early breast cancer. It may be noted that some of the data fields are same but some are different in these three sources of trail data. If the Indian clinical trial record is compared with other sources, WHO and clinicaltrials.gov, they are not the same in first glance but comparing the secondary IDs and drugs used and using domain knowledge, it may be concluded that the same trial is being represented by the three different sources, and hence a uniform representation with all the information pertaining to this trial from these three different sources needs to be clustered after removing the redundancies. Thus with the clustered data, any given clinical trial gets analyzed in one step. In the above example, if clustering was not there, one would have to analyze all the above three clinical trials separately. Through this method step, any incremental data also gets associated with the trail, such as, but not limited to, site and investigators data for the given trial from different sources. In the above example, there was a lot of information about the investigators and sites used in India sourced from Indian clinical trial registry but the same data was not present in other two sources (clinicaltrials.gov and WHO). Thus clustering ensures that all the data for any given trial gets associated to provide a complete set of information for every trial.

Baseline tagging of the collated clinical data is then done as shown at step 16 using non-indication parameters. A sample list of non-indication parameters is given in Table 1.

TABLE 1

| Trial | Trial | |
|---|---|---|
| Phase | Status | Study Type |
| 1. Phase I | 1. Planned | 1. Interventional Study |
| 2. Phase | 2. Open | 2. Observational Study |
| I/II | 3. Closed | 3. Dose Optimization/Dose Consolidation Study |
| 3. Phase II | 4. Com- | 4. Dose Titration Study |
| 4. Phase | pleted | 5. Investigator-Initiated Study |
| II/III | 5. Tempo- | 6. Extension Study |
| 5. Phase | rarily | 7. Pharmacoeconomics Study (HE&OR Study) |
| III | Closed | 8. Pharmacogenomics/Pharmacogenetics Study |
| 6. Phase | 6. Termi- | 9. Pilot Trial |
| III/IV | nated | 10. Pivotal Trial |
| 7. Phase | | 11. Postmarketing Surveillance (PMS) Study |
| IV | | 12. Proof-of-concept (POC) Study |
| | | 13. Registry Study |

Further the method involves creating a disease specific list of indication parameters, wherein the indication parameters are classified into main indication parameters and sub indication parameters. The steps involved in creating a list of indication parameters in an exemplary embodiment involves, collating all the clinical trials in a given indication area and listing down all the data pertaining to given parameter. For example, for endpoints, all the endpoints that are used in all the clinical trials collated are listed. Next, filtering is done to remove the redundant indication data. Next, the data collected pertaining to given parameter, is divided into different level, for example, two levels, first level being termed as Main parameter (also referred to as parent parameter) and second level called being termed as Sub-parameter (also referred to as child parameter). A sample of the Chronic Obstructive Pulmonary Disorder (COPD) indication parameter is listed in the Table 2 below:

TABLE 2

| Main Parameter | Sub-Parameter |
|---|---|
| Chronic Obstructive | 1. Emphysema |
| Pulmonary Disease | 2. Chronic Bronchitis |
| | 3. Stable Chronic Obstructive Pulmonary |
| | Disease |
| | 4. Symptomatic Chronic Obstructive |
| | Pulmonary Disease |
| | 5. Poorly Reversible Chronic Obstructive |
| | Pulmonary Disease |
| | 6. Partially Reversible Chronic Obstructive |
| | Pulmonary Disease |
| GOLD Stage 1/Mild | |
| Chronic Obstructive | |
| Pulmonary Disease | |
| GOLD Stage 2/Moderate | |
| Chronic Obstructive | |
| Pulmonary Disease | |
| GOLD Stage 3/Severe | |
| Chronic Obstructive | |
| Pulmonary Disease | |
| GOLD Stage 4/Very Severe | |
| Chronic Obstructive | |
| Pulmonary Disease | |
| Chronic Obstructive | 1. COPD with Asthma |
| Pulmonary Disease with | 2. COPD with Pulmonary Hypertension |
| Comorbid Conditions | 3. COPD with Hypertension |
| | 4. COPD with Coronary Heart Disease |
| | 5. COPD with Congestive Heart Failure |
| | 6. COPD with Chronic Cor Pulmonale |
| | 7. COPD with Gastrointestinal Disorders |
| | 8. COPD with Hypogonadism |
| | 9. COPD with Chronic Renal Failure (CRF) |
| Alpha-1 Proteinase | |
| Inhibitor Deficiency | |
| Asthma | |
| Asthma with Comorbid | 1. Asthma with Hypertension |
| Conditions | 2. Asthma with Coronary Heart Disease |
| Lung Transplant Patients | |
| Healthy Smokers | |
| Healthy Nonsmokers/ | |
| Ex-Smokers | |
| Healthy Volunteers | 1. Healthy Male Volunteers |
| | 2. Healthy Female Volunteers |
| Others | 1. COPD with Insomnia |
| | 2. Cystic Fibrosis |
| | 3. Patients with Gastroduodenal ulcer |
| | 4. Idiopathic Pulmonary Fibrosis (IPF) |
| | 5. Unspecified Chronic Respiratory Disease |
| | 6. Cigarette Smokers |
| | 7. Active SELECT trial Participant |

Another exemplary list of inclusion parameters as used in the method of the invention is given in Table 3:

TABLE 3

| Sl. | | |
|---|---|---|
| No. | Parameter | Sub Parameter |
| 1 | COPD | |
| 2 | Mild COPD/GOLD Stage 1 | |
| 3 | Moderate COPD/GOLD Stage 2 | |
| 4 | Severe COPD/GOLD Stage 3 | |
| 5 | Very Severe COPD/GOLD Stage 4 | |
| 6 | Patients with positive | |
| | bronchodilator reversibility | |
| 7 | Patients with negative | |
| | bronchodilator reversibility | |
| 8 | Obese subjects | Overweight subjects (Grade |
| | | 1 obesity, BMI = 25 to 29.9) |
| | | Obese subjects (Grade 2 |
| | | obesity, BMI = 30 to 39.9) |
| | | Morbid obesity (Grade 3 |
| | | obesity, BMI = 40) |
| 8 | Subjects with hypoxaemia | Hypoxaemia at rest |
| | | Hypoxaemia on exercise |
| 9 | Subjects with hyperinflated lungs | |
| 10 | Symptomatic COPD | |
| 11 | Stable COPD | |
| 12 | Hospitalized patients | |
| 13 | Outpatients | |
| 14 | Acute exacerbation of COPD | |
| 15 | Patients with Emphysema | |
| 16 | Patients with Alpha-1 AT | |
| | deficiency | |
| 17 | Patients with Chronic bronchitis | |
| 18 | Smokers/Subjects with a history | Current Smokers |
| | of smoking | Ex-Smokers |
| | | History of <10 pack years |
| | | History of > or = 10 |
| | | pack years |
| | | History of > or = 15 |
| | | pack years |
| | | History of > or = 20 |
| | | pack years |
| 19 | COPD patients with history of | Frequent exacerbations |
| | exacerbations | At least one exacerbation |
| | | within the past 1 year |
| | | Two or more exacerbations |
| | | within the past 1 year |
| | | At least one exacerbation |
| | | in past 2 years |
| | | At least two exacerbations |
| | | in past 2 years |
| | | At least one severe |
| | | exacerbation (requiring |
| | | hospitalization) in past |
| | | 2 years |
| 20 | Patients currently receiving | Bronchodilators |
| | or with a history of receiving | Beta-2 agonists |
| | COPD therapy | Anti-cholinergics |
| | | Short-acting beta-2 |
| | | agonists plus |
| | | anticholinergics |
| | | Methylxanthines |
| | | Corticosteroids |
| | | Inhaled corticosteroids |
| | | Systemic corticosteroids |
| | | Inhaled LABA plus |
| | | Corticosteroids |
| | | Stable COPD medication |
| | | Oxygen therapy |
| | | Pulmonary rehabilitation |
| | | Patients on mechanical |
| | | ventilation |

Similarly another list of exclusion parameters as used in the invention is given below in Table 4.

TABLE 4

| Sl. | | |
|---|---|---|
| No. | Parameter | Sub Parameter |
| 1 | Mild COPD/GOLD stage 1 | |
| 2 | Moderate COPD/GOLD stage 2 | |
| 3 | Severe COPD/GOLD stage 3 | |
| 4 | Very severe COPD/GOLD stage 4 | |
| 5 | Alpha-1 AT deficiency | |
| 6 | Poorly controlled COPD | Unstable COPD |
| | | Recent change in COPD |
| | | medication |
| | | Recent hospitalisation |
| | | due to COPD |
| 7 | Acute exacerbation of COPD | |
| | (AECOPD) | |
| 8 | History of COPD exacerbations | |
| 9 | History of life-threatening | |
| | pulmonary obstruction/ | |
| | exacerbation of COPD | |
| 10 | Hypoxaemia | Hypoxemia at rest |
| | | Hypoxemia during exercise |
| | | Hypoxemia on supplemental |
| | | oxygen |
| 11 | Pulmonary disease/condition | Bronchiectasis |
| | other than COPD | Asthma |
| | | Cystic fibrosis |
| | | Giant bullous disease |
| | | Interstitial lung disease |
| | | Lung cancer |
| | | Pleural pathology |
| | | Pneumonia |
| | | Pneumothorax |
| | | Primary ciliary dyskinesia |
| | | Pulmonary edema |
| | | Pulmonary fibrosis |
| | | Pulmonary hypertension |
| | | Pulmonary thromboembolic |
| | | disease |
| | | Sarcoidosis |
| | | Solitary nodule in the lung |
| | | Tuberculosis (known, active) |
| | | Tuberculosis sequalae |
| | | Unspecified chronic |
| | | respiratory disease |
| | | Chest x-ray abnormality |
| | | other than COPD |
| | | Pneumoconiosis |
| 12 | Patients with hematologic | |
| | disorder | |
| 13 | Bladder neck obstruction | |
| 14 | Immune disorder | |
| 15 | Neoplasm | Cancers |
| | | Cancers with specific |
| | | exceptions |
| 16 | Infections | |
| 17 | Ophthalmic disease | |
| 18 | Neurological disease | |
| 19 | Psychiatric disorder | Bipolar disease |
| | | Schizophrenia |
| | | Mental retardation |

An exemplary list of end-points as used in the method of the invention is given below in Table 5:

TABLE 5

| Sl. | | |
|---|---|---|
| No. | Parameter | Sub Parameter |
| 1 | Forced Expiratory Volume | FEV1 AUC |
| | in One Second (FEV1) | FEV1 Peak |
| | | FEV1 Trough |
| | | FEV1 PostBronchodilator |
| | | FEV1 PreBronchodilator |
| | | Serial FEV1 |
| 2 | Forced Inspiratory Volume | FIV1 PreBronchodilator |
| | in One Second (FIV1) | FIV1 PostBronchodilator |
| 3 | Forced Vital Capacity | FVC AUC |
| | (FVC) | FVC Peak |
| | | FVC Trough |
| | | FVC PostBronchodilator |
| | | FVC PreBronchodilator |
| | | Serial FVC |
| 4 | FEV1/FVC Ratio | |
| 5 | Peak Expiratory Flow Rate | Home PEFR |
| | (PEFR) | Clinic PEFR |
| | | Morning/AM PEFR |
| | | Evening/PM PEFR |
| | | PEFR PreBronchodilator |
| | | PEFR PostBronchodilator |
| 6 | Expiratory/Inspiratory | Maximum Expiratory Flow (MEF) |
| | Flow | Maximum Mid-Expiratory Flow |
| | | (MMEF) |
| | | Forced Expiratory Flow (FEF) |
| | | Peak Inspiratory Flow |
| | | Expiratory flow-limitation by |
| | | Forced oscillation technique |
| | | Peak Expiratory Flow |
| 7 | Inspiratory Capacity | IC Peak |
| | (IC) | IC Trough |
| | | IC at Rest |
| | | IC During Exercise |
| | | Isotime and Peak Exercise IC |
| | | End-of-Exercise IC |
| | | IC PreBronchodilator |
| | | IC PostBronchodilator |
| | | Hyperinflation |
| | | Static Inspiratory Capacity |
| 8 | Functional Residual | Predicted Functional Residual |
| | Capacity (FRC) | Capacity (FRC) |
| | | FRC PreBronchodilator |
| | | FRC PostBronchodilator |
| 9 | Vital capacity (VC) | Slow Vital Capacity (SVC) |
| | | Inspiratory Vital Capacity (IVC) |

Another exemplary list of indication parameters showing diagnostic/lab parameter is given in Table 6 below:

TABLE 6

| Parameter | Sub Parameter |
|---|---|
| Forced Expiratory Volume | FEV1 AUC |
| in One Second(FEV1) | FEV1 Peak |
| | FEV1 Trough |
| | FEV1 PostBronchodilator |
| | FEV1 PreBronchodilator |
| | Serial FEV1 |
| Forced Inspiratory Volume | FIV1 PreBronchodilator |
| in One Second (FIV1) | FIV1 PostBronchodilator |
| Forced Vital Capacity | FVC AUC |
| (FVC) | FVC Peak |
| | FVC Trough |
| | FVC PostBronchodilator |
| | FVC PreBronchodilator |
| | Serial FVC |
| FEV1/FVC Ratio | |
| Peak Expiratory Flow | Home PEFR |
| Rate (PEFR) | Clinic PEFR |
| | Morning/AM PEFR |
| | Evening/PM PEFR |
| | PEFR PreBronchodilator |
| | PEFR PostBronchodilator |
| Expiratory/Inspiratory | Maximum Expiratory Flow (MEF) |
| Flow | Maximum Mid-Expiratory Flow (MMEF) |
| | Forced Expiratory Flow (FEF) |
| | Peak Inspiratory Flow |
| Inspiratory Capacity | IC Peak |
| (IC) | IC Trough |
| | IC at Rest |
| | IC During Exercise |
| | Isotime and Peak Exercise IC |
| | IC PreBronchodilator |
| | IC PostBronchodilator |
| Vital capacity (VC) | Slow Vital Capacity (SVC) |
| Lung Volumes | Total Lung Capacity (TLC) |
| | Residual Volume (RV) |
| | Residual volume/Total Lung Capacity |
| | (RV/TLC) |
| | Functional Residual Capacity (FRC) |
| | Expiratory reserve volume (ERV) |
| | Tidal Volume (VT) |

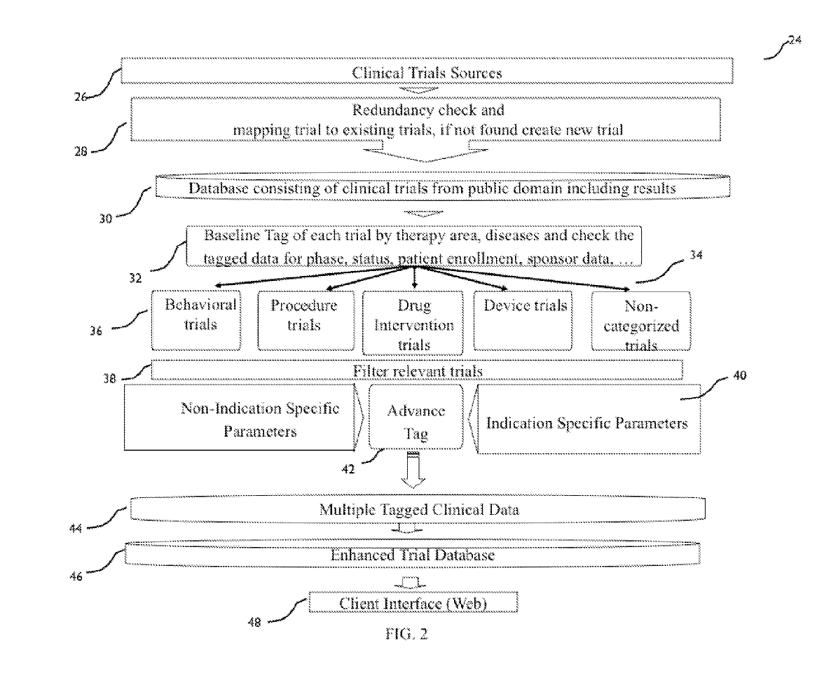

It will be appreciated by those skilled in the art that only exemplary lists are shown in above tables, and the lists include several other parameters needed for classification and tagging of the clinical trials. These aspects are shown in more detail in FIG. 2.

The method then involves the step for advanced tagging of the collated clinical trial data at step 18, using indication parameters as described above. All the relevant trials are thus categorized, analyzed and indexed based on parameters that depend on a given indication area.

Then using the baseline tagging and advanced tagging, the method involves creating multiple tagged clinical data as shown at step 20.

The method as described herein further allows for dynamic updating of the trial data information. In this respect the method includes mapping a new clinical trial information to an existing multiple tagged clinical data or creating a new multiple tagged clinical data from the new clinical trial information, if it is not an update for any existing record but a new trial data.

The method further comprises creating an enhanced trial database of the multiple tagged clinical data as indicated at step 22.

Thus through the method as described herein an enhanced trial database is made available that contains organized clinical trial data in the form of multiple tagged data and is available for further use for example through a web-enabled tool for searching and analyzing the clinical trial data.

Referring now to FIG. 2, a diagrammatic representation 24 of different components used or created by the method of FIG. 1 is illustrated in more details. The different clinical trial resources are indicated generally by reference numeral 26 that are used in the method of FIG. 1. The clinical trial information from all such resources is checked for redundancies, trial updates and also for new trials on a continuous or periodic basis as shown generally by reference numeral 28. This cleaned up data is stored in a database 30 and is then used for doing baseline tagging 32 using different attributes as indicated by reference numeral 34. Then the baseline tagged data is further filtered as shown at 36 to provide advanced tagged data 42 with non-indication and indication parameters as shown at 38 and 40 respectively. This leads to creation of multiple tagged clinical data 44 that is stored as an enhanced trial database 46 that can be accessed for example by a client interface 48.

It would be appreciated by those skilled in the art that the method described herein provides a repository of global clinical trials, which are organized systematically in order to facilitate easy retrieval with enhanced and current clinical trial information. It is useful for all those who are involved in design, execution, or analysis of clinical trials.

It may be appreciated by one skilled in the art that the method and process steps and algorithms described herein can be executed by means of software running on a suitable processor, or by any suitable combination of hardware and software. When software is used, the software can be accessed by a processor using any suitable reader device which can read the medium on which the software is stored. The computer readable storage medium can include, for example, magnetic storage media such as magnetic disc or magnetic tape; optical storage media such as optical disc, optical tape, or machine readable bar code; solid state electronic storage devices such as random access memory (RAM) or read only memory (ROM); or any other physical device or medium employed to store a computer program. The software carries program code which, when read by the computer, causes the computer to execute any or all of the steps of the methods disclosed in this application. Similarly a communication link that may be an ordinary link or a dedicated communication link may be provided for accessing the enhanced trial database as described herein from a user's work station.

While only certain features of the invention have been illustrated and described herein, many modifications and changes will occur to those skilled in the art. It is, therefore, to be understood that the appended claims are intended to cover all such modifications and changes as fall within the true spirit of the invention.

I/we claim:

1. A method for creating multiple tagged clinical trial data, the method comprising:
receiving clinical trial information from a plurality of sources;
removing redundancies from the clinical trial information received from the plurality of sources to form collated clinical trial data;
baseline tagging of the collated clinical data using non-indication parameters;
creating a disease specific list of indication parameters, wherein indication parameters are classified into main indication parameters and sub indication parameters;
advanced tagging of the collated clinical trial data using indication parameters; and
creating multiple tagged clinical data using baseline tagging and advanced tagging.

2. The method of claim 1 wherein the step of removing redundancies involves removing redundancies based on at least a statistical keyword match done for same clinical trial information from a source and/or from at least two sources from the plurality of sources.

3. The method of claim 1 wherein the collated data comprises clustered clinical trial data after removing the redundancies.

4. The method of claim 1 further comprising mapping a new clinical trial information to an existing multiple tagged clinical data.

5. The method of claim 1 further comprising creating a new multiple tagged clinical data from a new clinical trial information.

6. The method of claim 1 further comprising creating an enhanced trial database of the multiple tagged clinical data.

7. A tool for analyzing clinical trial information using the method of claim 1-6.

8. A computer program product comprising: a computer useable medium having a computer readable code including instructions for:
receiving clinical trial information from a plurality of sources;
removing redundancies from the clinical trial information received from the plurality of sources to form collated clinical trial data;
baseline tagging of the collated clinical data using non-indication parameters;
creating a disease specific list of indication parameters, wherein indication parameters are classified into main indication parameters and sub indication parameters;
advanced tagging of the collated clinical trial data using indication parameters; and
creating multiple tagged clinical data using baseline tagging and advanced tagging.

9. The computer program product of claim 8 further comprising mapping a new clinical trial information to an existing multiple tagged clinical data.

10. The computer program product of claim 8 further comprising creating a new multiple tagged clinical data from a new clinical trial information.

11. The computer program product of claim 8 further comprising creating an enhanced trial database of the multiple tagged clinical data.
